(19) United States
(12) Patent Application Publication
(10) Pub. No.: US 2020/0177702 A1
(43) Pub. Date: Jun. 4, 2020

(54) SYSTEM AND METHOD TO PROVIDE PRE-POPULATED PERSONAL PROFILE ON A SOCIAL NETWORK

(71) Applicant: Shocase, Inc., San Francisco, CA (US)

(72) Inventors: Ronald P. Young, Mill Valley, CA (US); Matthew Eugene Warburton, San Carlos, CA (US); David Anthony Burgess, Menlo Park, CA (US); Peter Rugg, New York, NY (US)

(73) Assignee: Shocase, Inc., San Francisco, CA (US)

(21) Appl. No.: 16/780,849

(22) Filed: Feb. 3, 2020

Related U.S. Application Data
(63) Continuation of application No. 16/200,628, filed on Nov. 26, 2018, now abandoned.
Application No. 16/200,628 is a continuation of application No. 14/626,012, filed on Feb. 19, 2015, now abandoned.
(60) Provisional application No. 61/941,639, filed on Feb. 19, 2014.

(51) Int. Cl. H04L 29/08; G06Q 50/00

(52) U.S. Cl. CPC H04L 67/306; H04L 63/08; H04L 67/1044; G06Q 50/01

(57) ABSTRACT

Methods, systems, and media are directed to the creation of a user-controlled, pre-populated personal information profile to be used in conjunction with social networks. The creation of the personal profile information includes electronically transmitting first instructions requesting entry of unique personal identification information of the potential new user, determining the validity of the received unique personal identifier information, and electronically transmitting second instructions requesting entry of profile information of the new user. Furthermore, processing the received profile information to generate a pre-populated personal profile of the new user, electronically transmitting the pre-populated personal profile in a form that is viewable and revisable to facilitate changes thereof, completing the registration process and establishing the newly-registered user personal information profile in the social network site.

### CROSS-REFERENCE TO RELATED APPLICATIONS

This application claims priority to U.S. Provisional Patent Appln. Ser. No. 61/941,639, filed Feb. 19, 2014 entitled, “System To Provide Pre-Populated Personal Profile on a Computerized Social Network.”

This application is also related to U.S. application Ser. No. 14/507,003, filed Oct. 6, 2014 entitled, “System and Method to Provide Collaboration Tagging for Verification and Viral Adoption,” which claims priority to U.S. Provisional Patent Appln. Ser. No. 61/887,423, filed Oct. 6, 2013 entitled, “A System and Method To Provide Collaboration Tagging for Viral Verification and Adoption.”

### FIELD OF THE INVENTION

The invention generally relates to aspects of networking site platforms and, more particularly to, user profile information that may be used in conjunction with networking site platforms.

### BACKGROUND OF THE INVENTION

Given their immense popularity, social networking websites have spawned in prodigious numbers across the globe. The attraction of these websites rests squarely on their ability to enable users to socially interact with other users by facilitating the sharing of user-generated content, such as, blogs, images, videos, messages, etc. Typically, users sign up with the social networking website by providing certain user information and the computer server that hosts the website provides access thereto.

For at least security and privacy reasons, individual users of social networking sites should be uniquely identified. To this end, each user generally has an associated user profile. Such profiles typically contain a name and some additional identifying information that may or may not include location address, telephone numbers, birthdate, government license, certificate numbers, educational background, work experience, gender data, and additional personal information.

The configuration and content of user profiles, including the use of additional personal information, is generally driven by the goals, purposes, and/or activities of the social networking sites. For example, some social networking sites automatically capture historic media selections of users and store them in their user profile in order to present similar media for purchase or use, while other sites automatically capture user activity and search data and stores such data in user profiles for future marketing of media, goods, and/or services that may be of interest to users. In so doing, these social networking sites typically configure user information profiles without meaningful input from the users themselves, as they are focused on addressing the sites' purposes and objectives more so than the users' needs or guidance.

And, while some other social networking sites allow for users to create user profiles, the creation and submission of personal information (e.g., uploading of documents, presentations, pictures, videos, etc.) is typically a laborious non-user friendly process. Still other social networking sites attempt to ease some of the drudgery of creating user profiles by allowing users to enter data that is selected from a contact database into certain fields of the user profile. However, those fields may be used by users to invite other non-users, thereby limiting the space of relevant pre-populated data as well as lacking any method of verifying the validity of the data in the user's contact database.

In so doing, it is clear that traditional social networking sites are configured to set up user information profiles that serve their own purposes and objectives without meaningful input or guidance from the users themselves.

### SUMMARY OF THE INVENTION

The invention, as disclosed herein, addresses the deficiencies and drawbacks noted above by providing systems and methods that are directed to a user-guided, pre-populated personal information profile to be used in conjunction with social networks.

The disclosed method embodies a computer-implemented method of creating a user-guided personal information profile to be used in conjunction with a social network site, the method being implemented by one or more physical processors of the social network site that are programmed with instructions which, when executed by the one or more physical processors, cause the social network site to perform the method, which comprises electronically receiving a request from a potential new user to register with the social network site; in response to the received request, electronically transmitting first instructions requesting entry of unique personal identification information of the potential new user; determining validity of the received unique personal identifier information; in response to determining the validity of unique personal identifier information, electronically transmitting second instructions requesting entry of profile information of the new user; processing the received profile information to generate a pre-populated personal profile of the new user; and electronically transmitting the pre-populated personal profile in a form that is viewable and revisable to facilitate changes thereof. Moreover, upon electronically receiving an indication of acceptance of the personal profile, completing the registration process and establishing the newly-registered user personal information profile in the social network site, wherein, in response to receipt of acceptance, automatically notifying previously-registered users of the social network site of the newly-registered user and providing the previously-registered users with access to the newly-registered user personal information profile.

The disclosed media embodies a computer-readable medium for creating a user-guided personal information profile to be used in conjunction with a social network, the medium having information recorded thereon which, when executed by a computer, causes the computer to perform the following: electronically receive a request from a potential new user to register with the social network site; in response to the received request, electronically transmit first instructions requesting entry of unique personal identification information of the potential new user; determine validity of the received unique personal identifier information; in response to determining the validity of unique personal identifier information, electronically transmit second instructions requesting entry of profile information of the new user; process the received profile information to generate a pre-populated personal profile of the new user; and electronically transmit the pre-populated personal profile in a form that is viewable and revisable to facilitate changes thereof. In addition, upon electronically receiving an indication of acceptance of the personal profile, complete the registration process and establish the newly-registered user personal information profile in the social network site, wherein, in response to receipt of acceptance, automatically notifying previously-registered users of the social network site of the newly-registered user and providing the previously-registered users with access to the newly-registered user personal information profile.

The disclosed system embodies a system for creating a user-guided personal information profile compromising: one or more memory storage devices; one or more communication modules configured to establish electronic communications and accommodate exchange of information; one or more physical processors programmed with instructions which, when executed, cause the system to: electronically receive a request from a potential new user to register with the social network site; in response to the received request, electronically transmit first instructions requesting entry of unique personal identification information of the potential new user; determine validity of the received unique personal identifier information; in response to determining the validity of unique personal identifier information, electronically transmit second instructions requesting entry of profile information of the new user; process the received profile information to generate a pre-populated personal profile of the new user; and electronically transmit the pre-populated personal profile in a form that is viewable and revisable to facilitate changes thereof. Furthermore, upon electronically receiving an indication of acceptance of the personal profile, complete the registration process and establish the newly-registered user personal information profile in the social network site, wherein, in response to receipt of acceptance, automatically notifying previously-registered users of the social network site of the newly-registered user and providing the previously-registered users with access to the newly-registered user personal information profile.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a general overview of an Internet-accessible social network site platform, in accordance with various aspects of the present disclosure.

FIG. 2 depicts a flow chart indicating a process to generate a user-guided, pre-populated personal information profile to be used in conjunction with social networks, in accordance with various aspects of the present disclosure.

FIG. 3 depicts certain elements of a user-guided, pre-populated personal information profile and range of unique identifiers that can apply to a new user, in accordance with various aspects of the present disclosure.

FIG. 4 depicts certain elements of a user-guided, pre-populated personal information profile and range of projects with which a new user may be associated, in accordance with various aspects of the present disclosure.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

As will be apparent by the ensuing description and illustrations, the disclosed embodiments relate to a user-guided, pre-populated personal information profile to be used in conjunction with a social network platform. The user-guided, pre-populated personal information profile is configured to interface with social networks to automatically gather desired and/or available information to populate the new user's personal profile, and presents the capability of reviewing, amending, verifying, and certifying the personal profile to the new user. In addition, the disclosed embodiments provide the opportunity to maintain and update such personal profiles automatically in response to additions, changes or other modifications in the sources of the compiled data, regardless of whether the user or others initiate such modifications.

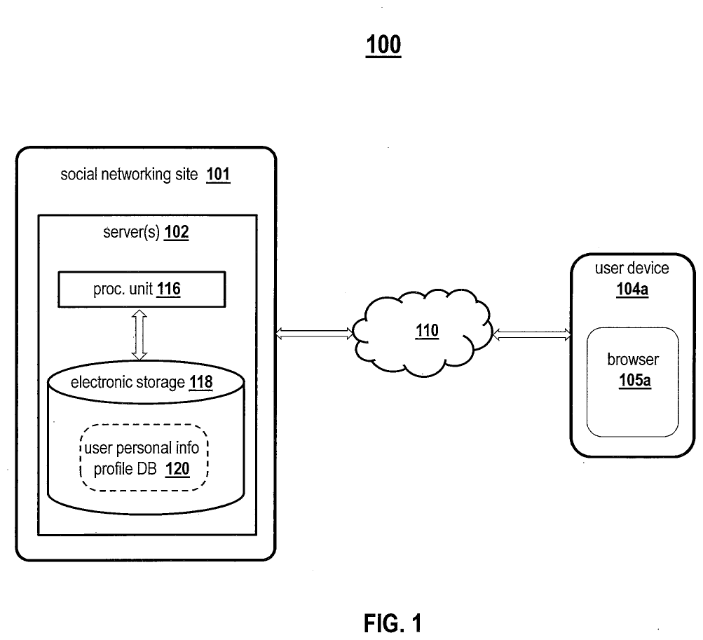

As such, FIG. 1 depicts a general overview of an Internet-accessible social network site system 100, in accordance with various aspects of the present disclosure. The platform of system 100 includes social networking website 101 that is hosted by server (or servers) 102, which are configured to communicate with, and process information from, remotely-situated user communication device(s) 104a via a communication facility, such as, for example, the Internet 110.

Server(s) 102 may embody one or more computing devices incorporating hardware components, operating systems, and programming languages that may be familiar to those skilled in the art in order to implement the processing as described herein. The computing devices may include one or more memory storage devices, such as, electronic storage device(s) 118 as well as one or more physical processing units 116 programmed with one or more computer program instructions to perform the functionality of social networking website 101, in addition to other components. As such, processing unit(s) 116 may embody one or more of a digital processor, analog processor, digital circuit designed to process information, analog circuit designed to process information, a state machine, and/or other mechanisms for electronically processing information. In some implementations, processing unit(s) 116 may include a plurality of processors that are physically located within the same computing device or may represent processing functionality of a plurality of devices operating in coordination.

The computing devices may also include communication module(s) designed to establish the communication and accommodate the exchange of information between social networking website 101 and user device(s) 104a or other computing platforms via the communication facility, such as, the Internet 110. The computing devices may further include a plurality of hardware, software, and/or firmware components operating together to provide the functionality attributed herein to server(s) 102. For example, the computing devices may be implemented by a cloud of computing platforms communicating and operating together.

As noted above, server(s) 102 may include memory storage devices, such as, electronic storage device(s) 118, which may store software algorithms, information generated by processing units 116, information received from other server(s) 102, information received from other computing platforms, or other information that enables the server(s) 102 to function as described herein. In particular, with regard to server(s) 102 of social networking website 101, electronic storage device(s) 118 may be configured to store information related to users, such as, for example, user-guided, pre-populated personal information profiles in database(s) 120. The database(s) 120 may include, or interface with, for example, an Oracle™ relational database, Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. It will be appreciated that database(s) 120 may comprise one or more such databases that reside in one or more physical devices and in one or more physical locations. The database(s) 120 may be configured to store a plurality of types of data and/or files and associated data or file descriptions, administrative information, or any other data.

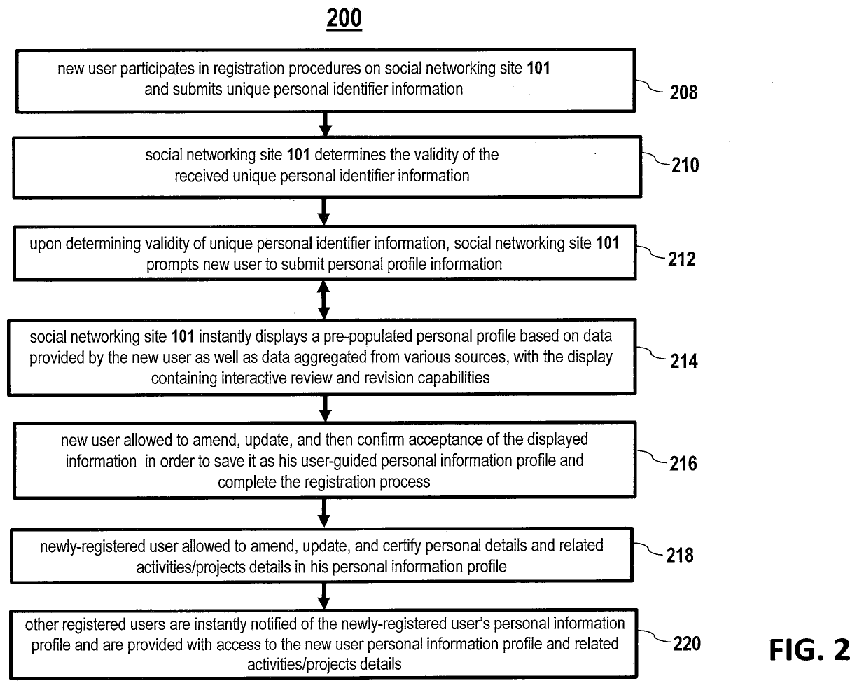

With this said, FIG. 2 depicts a functional flow chart of process 200, configured to create a user-guided, pre-populated personal information profile to be used in conjunction with social network site website 101. Process 200 is executed by processing unit(s) 116 containing programmed instructions to operate with information electronically provided by user device(s) 104a and results of electronic searches as well as information in electronic storage device(s) 118 and database(s) 120 to establish the user-guided, pre-populated personal information profile.

As depicted by task 208, process 200 is actuated when a new user accesses social network site website 101 and endeavors to interact/participate with website 101, by commencing registration procedures. In some embodiments, the initial communication with website 101 may be achieved by entering the address of website 101 (e.g., Uniform Resource Locator) in web browser 105a of the new user's device 104a. In other embodiments, the initial communication with website 101 may be actuated based on an application installed on the new user's device 104a. In turn, social network website server(s) 102 respond to the access requests of web browser 105a or installed application with instructions and scripts, compliant with standardized protocols (e.g., HyperText Markup Language (“HTML”)), that enables web browser 105a to display input query information and appropriately interact with server(s) 102 via standardized communication transactions. As such, social network website server(s) 102 may present one or more instructions and/or requests to user web browser 105a prompting the new user to input unique personal identifier information, such as, username(s), password(s) and/or other pieces of uniquely identifying data items, as part of the registration procedures.

Upon receipt of the unique personal identifier information by social network website server(s) 102, at task 210, process 200 evaluates the unique personal identifier information submitted by the new user to check for errant, inconsistent, and/or non-unique data stored in database(s) 120. That is, such checks may include identifying and reconciling usual errors, like misspellings, as well as determining whether the new user personal identifier information contains non-unique data items (i.e., non-unique data similar to other users of social network site website 101), such as, for example, the same name or the same password. Process 200 is configured to reconcile such non-unique data items in view of the totality of the personal identifier information provided, such as, looking to social security numbers (or portions thereof), email addresses, birthdates, home/work addresses, etc. In addition, such checks may further include determining whether any connections of the new user exist with projects that are presently resident on the social network site 101 as well as accessing publicly-available data associated with the user on other network sites.

Upon satisfactory check results confirming the validity of the new user's unique personal identifier information, the new user registration is accepted by social networking site 101. As such, process 200 then directs social network website server(s) 102 to transmit a message to new user web browser 105a that prompts the new user to enter profile information, as indicated by task 212. In some embodiments, should the new user's profile information on other network sites not be publicly available or accessible without access credentials, process 200 may be configured to request and/or prompt the new user for user access credentials to other network sites having profile data. Moreover, such profile information may include a wide array of new user-related attributes and data, such as, for example, user descriptions, user photographs, user name/aliases, user businesses/projects/activities, user skills/experience, user personal achievements and awards, user lists of contacts, user collaborators/colleagues, user market segments, user geolocation data, user professional accomplishments, user performances/competitions, user exhibits, user publications, user financial data, user information on one or more other network sites (e.g., LinkedIn/Google+/Facebook.com, etc.) as well as any other relevant information associated with the new user.

It should be appreciated that by submitting profile information, including identification and access credentials of other network sites having his personal profile information, the new user has permitted his registered account on social network website 101 to access information related to him that is contained in one or more of his accounts on other network sites. As author and owner of such information, this enables the new user to be more involved in guiding what information is to be included in his own personal information profile. In one embodiment, there is no cross-linkage with other network sites, so that other network sites will not be updated with the personal profile data provided by the new user on social website 101. However, other embodiments contemplate the capability, based on certain arrangements with other network sites, to update the personal profile data provided by the new user with other network sites.

Upon receipt of such personal profile information, social network website server(s) 102 processes the received information to immediately execute searches to retrieve the profile information associated with the user from other network sites. The retrieved profile information may be further processed by parsing, interpreting, consolidating, formatting, and storing the information in database 120 to provide a consolidated pre-populated profile. For example, the personal profile information may be sorted and parsed from a resume into sections for different jobs, education, received awards, non-profit activities, publications, etc. The new user has the ability to edit, augment, and/or delete any of these sections, or just accept them as is.

Moreover, for any activities found on other network sites associated with the new user, such activities may be set up as new projects. In so doing, for a new project, process 200 may prompt the new user for the names of collaborators and their roles regarding the new project. In other embodiments, publicly-mentioned collaborators may be added based on confirmation by the new user regarding their role in the project. It will be appreciated that any financial, location, information or search history associated with the new user would be stored confidentially (e.g., hidden files) and not made publicly available in the personal profile.

Armed with all of the new user-related information, at task 214, process 200 presents the new user, in real-time (i.e., virtually instantaneously given processing and transmission limitations), with a display of a pre-populated personal profile on web browser 105a. The pre-populated personal profile is configured to aggregate all of the new user relevant information, including user-submitted information as well as information retrieved from other sources, including other network sites. The display of the pre-populated personal profile on web browser 105a is further configured to enable the new user with capabilities to revise the pre-populated personal profile information presented as well as confirm acceptance of the established the new user, user-guided personal information profile.

With regard to revision capabilities, process 200 (as indicated by the bidirectional arrow between tasks 212, 214) enables the new user to interactively review the pre-populated personal profile information and add, delete, modify, and/or update the displayed contents as well submit augmenting information to facilitate additional searches and extend the range of sources relied on for personal profile data. The interactive revisions and corresponding displays may be executed in real-time. Once the new user is satisfied with the information of the displayed pre-populated personal profile, the new user may confirm the acceptance of the displayed information as his user-guided personal information profile which will be saved, thereby completing the registration process, as indicated by task 216.

It will be appreciated that, in some embodiments, the aggregated, pre-populated personal profile may comprise additional personal identifiers that may be unique, such as social security number (or portions thereof), email addresses, cell phone numbers, written profile of the new user and other information, projects, events, or colleagues from the social networking system where such data has been associated with the new user's personal identifier. In the event that a personal identifier remains as being non-unique, it is contemplated that during the interactive review/revision process (as indicated by the bidirectional arrow between tasks 212, 214), the new user may accept or reject pieces of information and/or data items.

Process 200 also allows the newly-registered user with the ability to amend, update, and certify personal profile details and related activities/projects details in order to keep such details current and relevant, as noted by task 218. Then, at task 220, process 200 instantly provides other registered users with notification of the newly-registered user as well as automatically enabling access of the newly-registered user personal information profile and related activities/projects details to other registered users. At this stage, the newly-registered user (whether invited by other registered users or not), will be able to see projects to which he has been named as a collaborator, colleague, and/or participant (e.g., via one of the email addresses in the user personal profile). And, process 200 also permits the newly-registered user to modify the previously entered projects, and if need be, revise or update the associated information included therein, such as, for example, the newly-registered user's title, newly-registered user's role in certain projects, revise description of awards won, etc.

In so doing, process 200 uniquely enables a user to create a current, accurate, and relevant personal information profile that focuses on information, and the presentation thereof, that the user deems to be an accurate representation of himself and his interests/activities without such information being filtered by the varying agendas of network websites. Equally notable, by exploiting and consolidating relevant user information from other network sites to pre-populate the personal profile, process 200 enables the user to create the personal information profile in a dramatically more time-efficient and less task-intensive manner than conventional methods. And by automatically notifying and providing access to the personal information profile to other users, process 200 promotes potentially greater exposure of such information to a wider audience instantaneously.

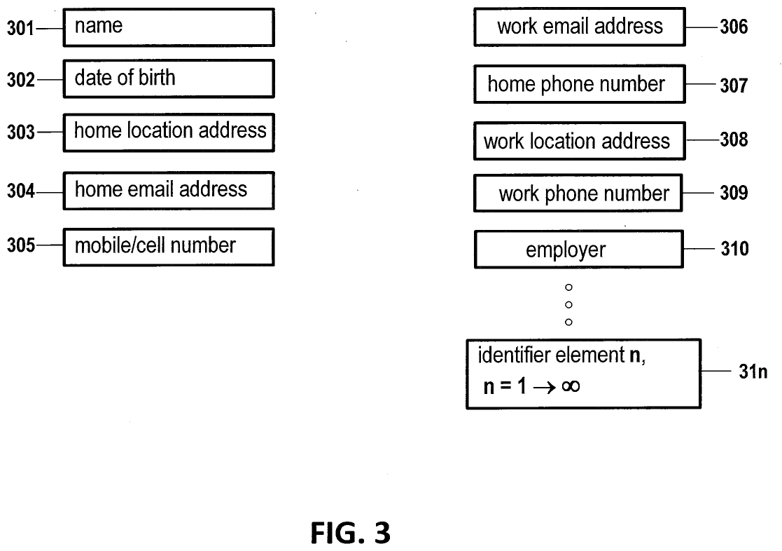

FIG. 3 depicts certain elements of a user-guided, pre-populated user personal information profile and range of unique identifiers that can apply to a new user, in accordance with various aspects of the present disclosure. In particular, FIG. 3 demonstrates an exemplary portion of the formatted fields and associated information that system 100 may include in the personal information profile. For example, name field 301 accommodates user name data and while a user's name is a personal identifier, system 100 treats it as a unique individual identifier when accompanied by second personal identifier information, such as, for example, birthdate data in field 302 or user home location data in field 303. Other fields that may be implemented to accommodate personal identifier information may include current or past company, title, location, profile pictures, and/or project assets.

Because it may still be possible for two people with the same name, and the same date of birth to reside in the same location, system 100 will further employ additional individual personal identifier data, such as, for example, home email address data in field 304 or a mobile/cellular phone number data in field 305. While the combination of a name and a home email address may adequately identify a certain individual, system 100 may uniquely contain more than one personal identifier for a user, such as, work email address data in field 306, home phone number data in field 307, work location address data in field 308, work phone number data in field 309, or employer data in field 310. These additional identifiers may or may not constitute part of the user personal information profile, but will be stored in database 120 as auxiliary data for confirmation purposes.

It should be appreciated that users' needs, livelihoods, and preferences change over time, such as, for example, new job opportunities, new home locations, changes in ISPs, changes to different cellphone carriers, etc. And, such changes affect the timeliness and relevancy of user personal information. In view of the potential for change, system 100 is designed to take such changes into account. In particular, as noted by field 31n of FIG. 3, system 100 is configured to accommodate a vast number of additional personal identifiers. Such capabilities facilitates the cross-referencing of numerous and updated different personal identifiers that provides users with a wider range of connectivity to other social network users, thereby significantly improving the utility of system 100.

By way of exemplary embodiments, system 100 encompasses social networking website 101 that may be directed to supporting and promoting the collaboration and participation of projects/activities amongst like-minded users. Such projects/activities may take a variety of forms, such as, for example, work or tasks completed, sporting events, works of art, educational courses, or any other endeavor that relates to the qualifications, skills, experiences, and/or accomplishments of a user. To this end, social networking website 101 permits the identification of other users, i.e., participants/potential collaborators that have participated in similar or related projects/activities. It also promotes the identification of purchasers who may be interested in the work that a user has produced and posted as a project.

Consistent with such embodiments, users of social networking website 101 may include additional unique personal identifiers that provide information regarding their participation in similar or related projects/activities. System 100 is configured to instantly search database 120 of social network website server(s) 102 to locate projects/activities in which a user with such additional personal identifiers is classified as a participant/potential collaborator. Social networking website 101 will display such information in the new user's personal profile. In some embodiments, social networking website 101 will include the opportunity for referencing a user's contribution to the project/activity by tagging one or more personal identifier elements, such as, for example, a user's email address or mobile/cell phone. Should a user have different personal identifier elements for different projects (i.e., different work email addresses for different projects), his complete user personal profile can be consolidated by system 100, thereby enhancing the value of social networking website 101 to the user.

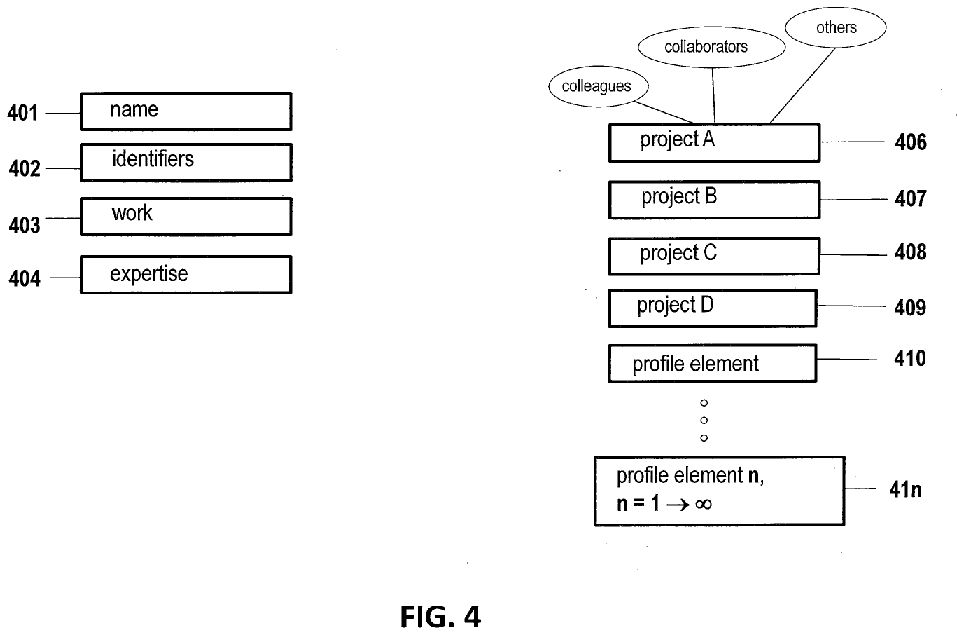

Given the capabilities of system 100, FIG. 4 demonstrates an exemplary portion of the formatted fields and associated information that system 100 may include in the personal information profile to support and promote the collaboration/participation of projects/activities amongst like-minded users. For example, name field 401 accommodates user name data, personal identifier field 402 accommodates personal identifier data, as discussed above, while work field 403 accommodates the description of work done by the user, and field 404 accommodates the explanation of a user's expertise.

Moreover, fields 406-409 accommodate data that indicate specific project/activity data in which the user has previously participated in or is currently engaged with. It is contemplated that these project/activity data descriptions may further indicate that the user was part of a team of tagged collaborators, or there may be a more detailed description of the role that the profiled user played in the project/activity. For example, field 406 may contain a listing of tagged colleagues or collaborators or others with whom the user is associated with or has worked with in the past. These tagged colleagues, collaborators, and other individuals may or may not be registered users on network site 101.

Moreover, system 100 is configured to provide continuous automatic personal profile updating, unlike any conventional social network profile. That is, system 100 continuously updates personal profile information based on any changes in the profile data linked with other social network systems. And, when any additional new project/activity is set up or prior project/activity is amended on social networking website 101, every user of social networking website 101 who has been tagged for collaborating on related projects/activities has his associated consolidated personal profile updated for the new information, instantly, and automatically, without having to sign in or engage the system.

Returning back to FIG. 4, field 410 depicts a generic, unspecified profile element that may comprise a picture of the user, additional personal data, additional project, or any other element of data connecting the user with the purpose and field of system 100. Furthermore, as shown by field 41n, system 100 is configured to accommodate a vast number of additional profile elements. With such a wide array of potential elements, system 100 manifests the capability of providing greater exposure of information to a wider audience instantaneously.

In some embodiments, changes in any of the linked or interconnected personal profile information may be flagged for the user with a suggestion that further updating of the profile may be useful. As personal profiles of users are often used in searches for talent, expertise or employment, the regular and automatic updating of personal profile information can be of high value to a user.

In addition, while the aforementioned description may imply a predetermined order of tasks, it will be appreciated that certain tasks may be performed throughout the user registration/account creating process. For example, tasks 208-212 of process 200, namely, electronically receiving a request from a potential new user to register, electronically transmitting first instructions requesting entry of unique personal identification information, determining validity of the received unique personal identifier information, and in response to determining the validity of unique personal identifier information, electronically transmitting second instructions requesting entry of profile information may be performed at any stage of the user registration/account creating process and in different orders. Indeed, for some embodiments, process 200 may be configured to proactively gather profile information from public sources of participants in publicized events or projects. The profile information may then be associated with unique personal identifier(s) of non-user participants. In this manner, should a non-user participant desire to become a new user, process 200 proactively provides the new user with a much faster and more robust instant profile to present for editing and acceptance, before the new user assigns a password to complete the registration process.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of creating a user-guided personal information profile to be used in conjunction with a social network site, the method being implemented by one or more physical processors of the social network site that are programmed with instructions which, when executed by the one or more physical processors, cause the social network site to perform the method, comprising:
electronically receiving a request from a potential new user to register with the social network site;
in response to the received request, electronically transmitting first instructions requesting entry of unique personal identifier information of the potential new user;
determining validity of the received unique personal identifier information;
in response to determining the validity of unique personal identifier information, requesting and receiving, from the new user, identification and user access data for at least one other network site requiring user credentials for access;
electronically transmitting second instructions requesting entry of profile information of the new user, wherein the transmitted second instructions requesting entry of profile information includes the identification and user access data for the at least one other network site requiring user credentials for access;
processing the received profile information to generate a pre-populated personal profile of the new user, wherein the processing of the received personal profile information includes automatically retrieving profile information authored and/or owned by the new user from the at least one other network site requiring user credentials;
electronically transmitting the pre-populated personal profile in a form that is viewable and revisable to facilitate changes thereof by the new user including changes to the profile information retrieved from the at least one other network site;
and upon electronically receiving an indication of acceptance of the personal profile, completing the registration process and establishing the newly-registered user personal information profile in the social network site, wherein, in response to receipt of acceptance, automatically notifying previously-registered users of the social network site of the newly-registered user and providing the previously-registered users with access to the newly-registered user personal information profile.

2. The computer-implemented method of claim 1, wherein the received request to register is electronically transmitted by a remote communication device associated with the new user.

3. The computer-implemented method of claim 2, wherein the electronically transmitted request to register is generated by inputting an address associated with the social network site on the communication device or actuated by an application associated with the social network site on the communication device.

4. The computer-implemented method of claim 1, wherein the determination of the validity of the received unique personal identifier information includes determining any projects presently resident on the social network site for which the new user is a collaborator, wherein a given project represents at least one endeavor relating to qualifications, skills, experiences, and/or accomplishments of the new user.

5. The computer-implemented method of claim 4, wherein determining any projects presently resident on the social network site for which the new user is a collaborator comprises determining any projects presently resident on the social network site for which the new user was previously tagged as a collaborator by a previously-registered user of the social network site.

6. The computer-implemented method of claim 5, wherein determining any projects presently resident on the social network site for which the new user was previously tagged as a collaborator by a previously-registered user of the social network site comprises determining whether the received unique personal identifier information matches unique personal identifier information for the collaborator previously provided by the previously-registered user.

7. The computer-implemented method of claim 5, wherein the received unique identifier information comprises a plurality of unique personal identifiers for the new user, and wherein determining any projects presently resident on the social network site for which the new user was previously tagged as a collaborator by a previously-registered user of the social network site comprises determining whether any of the plurality of unique personal identifiers for the new user matches unique personal identifier information for the collaborator previously provided by the previously-registered user.

8. The computer-implemented method of claim 7, wherein the plurality of unique personal identifiers comprises:
at least one email address or phone number currently associated with the new user; and
at least one email address or phone number previously associated with the new user.

9. The computer-implemented method of claim 4, further comprising permitting the new user to tag additional collaborators for any projects presently resident on the social network site for which the new user is a collaborator.

10. The computer-implemented method of claim 9, wherein the new user is permitted to tag additional collaborators who are not previously-registered members of the social network site.

11. The computer-implemented method of claim 1, wherein the determining of the validity further includes accessing publicly-available information associated with the new user from other network sites.

12. The computer-implemented method of claim 1, wherein the pre-population of the consolidated personal profile includes one or more of the following: user financial information, information on user's projects and activities, information on user's collaborators and colleagues, user awards, user presentations, user publications, and advertisements related to the user.

13. The computer-implemented method of claim 1, wherein the viewable and revisable form of the pre-populated profile includes the interactive editing, correcting, and display of the profile in real-time.

14. The computer-implemented method of claim 1, wherein determining the validity of the received unique personal identifier information includes reconciling non-unique data items, based on a totality of the personal identifier information, to verify a unique profile of the new user.

15. The computer-implemented method of claim 1, further comprising updating the at least one other network site in accordance with the changes by the new user to the profile information retrieved from the at least one other network site.

16. The computer-implemented method of claim 1, further comprising:
responsive to electronically transmitting the pre-populated personal profile, receiving from the new user identification and user access data for at least one additional network site requiring user credentials for access; and
updating the pre-populated personal profile with profile information associated with the new user automatically retrieved from the at least one additional network site requiring user credentials.

17. The computer-implemented method of claim 16, further comprising electronically transmitting the updated profile in a form that is viewable and revisable to facilitate changes thereof by the new user including changes to the profile information retrieved from the at least one additional network site.

18. The computer-implemented method of claim 1, wherein a given previously-registered user of the social network site is automatically notified of the newly-registered user regardless of whether the newly-registered user was invited by the given previously-registered user.

19. The computer-implemented method of claim 1, wherein the determination of the validity of the received unique personal identifier information includes determining any completed projects presently resident on the social network site which the new user worked on.

20. The computer-implemented method of claim 1, wherein the determination of the validity of the received unique personal identifier information includes determining any projects presently resident on the social network site which the new user previously worked on.

21. A non-transitory computer-readable medium for creating a user-guided personal information profile to be used in conjunction with a social network, the medium having information recorded thereon which, when executed by a computer, causes the computer to perform the following:
electronically receive a request from a potential new user to register with the social network site;
in response to the received request, electronically transmit first instructions requesting entry of unique personal identifier information of the potential new user;
determine validity of the received unique personal identifier information;
in response to determining the validity of unique personal identifier information, request and receive, from the new user, identification and user access data for at least one other network site requiring user credentials for access;
electronically transmit second instructions requesting entry of profile information of the new user, wherein the transmitted second instructions requesting entry of profile information includes the identification and user access data for the at least one other network site requiring user credentials for access;
process the received profile information to generate a pre-populated personal profile of the new user, wherein the processing of the received personal profile information includes automatically retrieving profile information authored and/or owned by the new user from the at least one other network site requiring user credentials;
electronically transmit the pre-populated personal profile in a form that is viewable and revisable to facilitate changes thereof by the new user including changes to the profile information retrieved from the at least one other network site;
and upon electronically receiving an indication of acceptance of the personal profile, complete the registration process and establish the newly-registered user personal information profile in the social network site, wherein, in response to receipt of acceptance, automatically notifying previously-registered users of the social network site of the newly-registered user and providing the previously-registered users with access to the newly-registered user personal information profile.

22. The computer-readable medium of claim 21, wherein the received request to register is electronically transmitted by a remote communication device associated with the new user.

23. The computer-readable medium of claim 22, wherein the electronically transmitted request to register is generated by inputting an address associated with the social network site on the communication device or actuated by an application associated with the social network site on the communication device.

24. The computer-readable medium of claim 21, wherein the determining of the validity further includes accessing publicly-available information associated with the new user from other network sites.

25. The computer-readable medium of claim 21, wherein the viewable and revisable form of the pre-populated profile includes the interactive editing, correcting, and display of the profile in real-time.

26. A system for creating a user-guided personal information profile, the system compromising:
one or more memory storage devices;
one or more communication modules configured to establish electronic communications and accommodate exchange of information;
one or more physical processors programmed with instructions which, when executed, cause the system to:
electronically receive a request, via the one or more communication modules, from a potential new user to register with the system;
in response to the received request, electronically transmit, via the one or more communication modules, first instructions requesting entry of unique personal identifier information of the potential new user;
determine validity of the received unique personal identifier information;
in response to determining the validity of unique personal identifier information, request and receive, from the new user, identification and user access data for at least one other network site requiring user credentials for access;
electronically transmit, via the one or more communication modules, second instructions requesting entry of profile information of the new user, wherein the transmitted second instructions requesting entry of profile information includes the identification and user access data for the at least one other network site requiring user credentials for access;
process the received profile information to generate a pre-populated personal profile of the new user, wherein the processing of the received personal profile information includes automatically retrieving profile information authored and/or owned by the new user from the at least one other network site requiring user credentials;
electronically transmit, via the one or more communication modules, the pre-populated personal profile in a form that is viewable and revisable to facilitate changes thereof by the new user including changes to the profile information retrieved from the at least one other network site;
and upon electronically receiving an indication of acceptance of the personal profile, complete the registration process and save the newly-registered user personal information profile in the one or more memory storage devices, wherein, in response to receipt of acceptance, automatically notifying previously-registered users of the system of the newly-registered user and providing the previously-registered users with access to the newly-registered user personal information profile.

27. The system of claim 26, wherein the received request to register is electronically transmitted by a remote communication device associated with the new user.

28. The system of claim 27, wherein the electronically transmitted request to register is generated by inputting an address associated with the system on the communication device or actuated by an application associated with the system on the communication device.

29. The system of claim 26, wherein the determining of the validity further includes accessing publicly-available information associated with the new user from other network sites.

30. The system of claim 26, wherein the viewable and revisable form of the pre-populated profile includes the interactive editing, correcting, and display of the profile in real-time.
